(19) United States
(12) Patent Application Publication
(10) Pub. No.: US 2023/0221021 A1
(43) Pub. Date: Jul. 13, 2023

(54) AIR CONDITIONING FACILITY FOR PREVENTING SPREAD OF INFECTIOUS DISEASE

(71) Applicant: WEDREAMON CO., LTD., Suwon-si, Gyeonggi-do (KR)

(72) Inventor: Jae Hyun PARK, Seoul (KR)

(73) Assignee: WEDREAMON CO., LTD., Suwon-si, Gyeonggi-do (KR)

(21) Appl. No.: 18/000,332

(22) PCT Filed: Oct. 22, 2021
(86) PCT No.: PCT/KR2021/014962

§ 371 Date: Nov. 30, 2022

(30) Foreign Application Priority Data
Oct. 30, 2020 (KR) 10-2020-0142874
Sep. 1, 2021 (KR) 10-2021-0116586

(51) Int. Cl. F24F 8/22; F24F 3/167

(52) U.S. Cl. CPC F24F 8/22; F24F 3/167; F24F 2221/14

(57) ABSTRACT

Proposed is an air conditioning facility for preventing spread of an infectious disease, the air conditioning facility including a first chamber having a plurality of air discharge holes configured to allow air processed by an air conditioner to be discharged toward an indoor space, an air suction pipe connected to the indoor space and a suction hole of the air conditioner and having a suction end configured to allow air to be suctioned from the indoor space; and an ultraviolet light irradiation unit disposed on a path in which air suctioned from the air suction pipe is discharged through the air discharge holes and configured to emit UV light for sterilization.

### TECHNICAL FIELD

The present disclosure relates generally to an air conditioning facility for preventing spread of an infectious disease. More particularly, the present disclosure relates to an air conditioning facility for preventing spread of an infectious disease, the air conditioning facility having an ultraviolet (UV) sterilization means and a vertical laminar flow-type air conditioning means.

### BACKGROUND ART

Recently, it has been reported that the corona virus spreads through air conditioners in indoor spaces, leading to group infection. The use of an air conditioner indoors may cause some air to flow laterally or form a convective or turbulent flow, thereby increasing the probability that source of infection from a person's respiratory system can be directly transmitted to another person's respiratory system. In addition, as the infected air is suctioned back into the air conditioner and discharged, it can quickly spread the source of infection to the entire indoor space. Furthermore, the infected air can spread the source of infection to other indoor spaces through ventilation holes. As described above, airborne source of infection such as the coronavirus can easily spread in indoor spaces where air conditioners are operated.

To block the spread of airborne source of infection in indoor spaces, a technique of ultraviolet (UV) irradiation of air is well known in the art. As an example, there is a method of introducing sterilized air into indoor spaces by irradiating air discharged through an air inlet of an indoor ceiling, an air purifier, an air conditioner, and the like with UV light. However, in the case of viruses floating in aerosol form in the air, such as the coronavirus, the sterilization effect is quite limited when the UV-C exposure time is not sufficiently secured. In the above method, the sterilization effect is insignificant because the sterilization time is short.

The background art of the present disclosure is disclosed in Korean Patent No. 10-1189477 (registered on Oct. 4, 2012, title of the invention: an air cleaner having a function of sterilization with ultraviolet light emitting diode (UVLED)).

### DISCLOSURE

### Technical Problem

Accordingly, the present disclosure has been made keeping in mind the above problems occurring in the related art, and an objective of the present disclosure is to provide an air conditioning facility for preventing spread of an infectious disease, the air conditioning facility being capable of blocking spread of infectious diseases caused by horizontal movement, convective flow, turbulent flow of air through sterilization based on ultraviolet (UV) irradiation and air conditioning based on vertical laminar flow.

### Technical Solution

In order to accomplish the above objective, the present disclosure provides an air conditioning facility for preventing spread of an infectious disease, the air conditioning facility including: a first chamber having a plurality of air discharge holes configured to allow air processed by an air conditioner to be discharged toward an indoor space; an air suction pipe connected to the indoor space and a suction hole of the air conditioner and having a suction end configured to allow air to be suctioned from the indoor space; and an ultraviolet light irradiation unit disposed on a path in which air suctioned from the air suction pipe is discharged through the air discharge holes and configured to emit UV light for sterilization.

Furthermore, the ultraviolet light irradiation unit may include a UV-C light emitting diode.

Furthermore, the ultraviolet light irradiation unit may be disposed at least one of inside the air suction pipe and on an upper surface of the first plate of the first chamber.

Furthermore, the air suction pipe may be made of a soft material or may be provided in the form of a bellows.

Furthermore, the suction end may be disposed in a lower area of the indoor space.

Furthermore, the suction end may be provided in a plate shape and may extend a predetermined distance from a wall in the indoor space.

Furthermore, the air conditioning facility may further include a second chamber spaced apart from the first chamber and having a plurality of air suction holes configured to allow air to be suctioned from the indoor space.

Furthermore, the suction end may include a plurality of suction ends, and the plurality of suction ends may be connected to the second chamber.

Furthermore, the plurality of suction ends may extend from a wall of the indoor space to have different lengths and may be disposed inside the second chamber.

Furthermore, cross-sectional areas of the plurality of suction ends may increase as extension lengths thereof from the wall of the indoor space increase.

Furthermore, an interval between the plurality of air suction holes may increase as a distance thereof from the suction end decreases.

Furthermore, diameters of the plurality of air suction holes may decrease as a distance thereof from the suction end decreases.

Furthermore, the air conditioning facility may further include an air discharge pipe connected to a discharge hole of the air conditioner and the first chamber, and configured to supply air processed by the air conditioner to the first chamber.

Furthermore, the air discharge pipe may include a plurality of air discharge pipes, and the plurality of air discharge pipes may be branched from the discharge hole of the air conditioner.

Furthermore, the ultraviolet light irradiation unit may be disposed inside the air discharge pipe.

Furthermore, an interval between the plurality of air discharge holes may increase as a distance thereof from the air discharge pipe decreases.

Furthermore, diameters of the plurality of air discharge holes may decrease as a distance thereof from the air discharge pipe decreases.

Furthermore, the air conditioning facility may further include an air discharge tube connected to each of the air discharge holes, and configured to induce air discharged from the air discharge hole to flow vertically toward the indoor space.

Furthermore, the air discharge tube may extend upward or downward from the first plate of the first chamber.

### Advantageous Effects

An air conditioning facility for preventing spread of an infectious disease according to the present disclosure can effectively block spread of airborne infectious diseases by circulating and supplying UV-C sterilized air in a vertical laminar flow manner through the use of simple equipment or remodeling, while using a conventional air conditioner.

Furthermore, the air conditioning facility for preventing spread of the infectious disease according to the present disclosure can induce a vertical laminar flow of air, thereby minimizing spread of airborne infectious diseases caused by horizontal movement, convective flow, and turbulent flow of air.

Furthermore, the air conditioning facility for preventing spread of the infectious disease according to the present disclosure can increase sterilization efficiency by irradiating air suctioned into and discharged from the air conditioner with UV-C light for a maximum period of time.

Furthermore, the air conditioning facility for preventing spread of the infectious disease according to the present disclosure can protect the human body by preventing the human body from being exposed to UV-C light.

Furthermore, the air conditioning facility for preventing spread of the infectious disease according to the present disclosure can maintain the flow rate and speed of air discharged into or suctioned from an indoor space constant regardless of position.

### DESCRIPTION OF DRAWINGS

FIG. 1 is a view schematically illustrating the configuration of an air conditioning facility for preventing spread of an infectious disease according to a first embodiment of the present disclosure.

FIG. 2 is a plan view schematically illustrating the configuration of a first chamber according to the first embodiment of the present disclosure.

FIGS. 3 and 4 are side views schematically illustrating the configuration of the first chamber according to the first embodiment of the present disclosure.

FIG. 5 is a sectional view schematically illustrating the configuration of an air suction pipe according to the first embodiment of the present disclosure.

FIG. 6 is a perspective view schematically illustrating the configuration of an air conditioning facility for preventing spread of an infectious disease according to a second embodiment of the present disclosure.

FIG. 7 is a perspective view schematically illustrating the configuration of an air conditioning facility for preventing spread of an infectious disease according to a third embodiment of the present disclosure.

FIG. 8 is a perspective view schematically illustrating the configuration of a second chamber according to a fourth embodiment of the present disclosure.

FIG. 9 is a perspective view schematically illustrating the configuration of an air conditioning facility for preventing spread of an infectious disease according to a fifth embodiment of the present disclosure.

### BEST MODE

Hereinafter, an exemplary embodiment of an air conditioning facility for preventing spread of an infectious disease according to the present disclosure will be described with reference to the accompanying drawings.

In the figures, thicknesses of lines or sizes of components may be exaggerated for the sake of convenience and clarity of explanation. Further, technical terms, as will be mentioned hereinafter, are terms defined in consideration of their function in the present disclosure, which may be varied according to the intention of a user, practice, or the like, so that the terms should be defined on the basis of the contents of this specification.

It will be understood that when an element is referred to as being “coupled (or connected)” to another element, it can be directly coupled (or connected) to the other element or intervening elements may be present therebetween. Unless the context clearly indicates otherwise, it will be further understood that the terms “comprise (or include)”, when used herein, specify the presence of stated components, but do not preclude the presence or addition of one or more other components.

The same reference numerals are used throughout the different drawings to designate the same or similar components. Even when reference numerals for the same or similar components are not mentioned or described in a particular drawing, the reference numerals may be described on the basis of other drawings. Further, even when there are parts to which reference numerals are not indicated in a particular drawing, those parts may be described on the basis of other drawings. The relative differences in the number, shape, size, and size of components included in the drawings are set for convenience of understanding, and do not limit embodiments of the present disclosure and may be implemented in various forms.

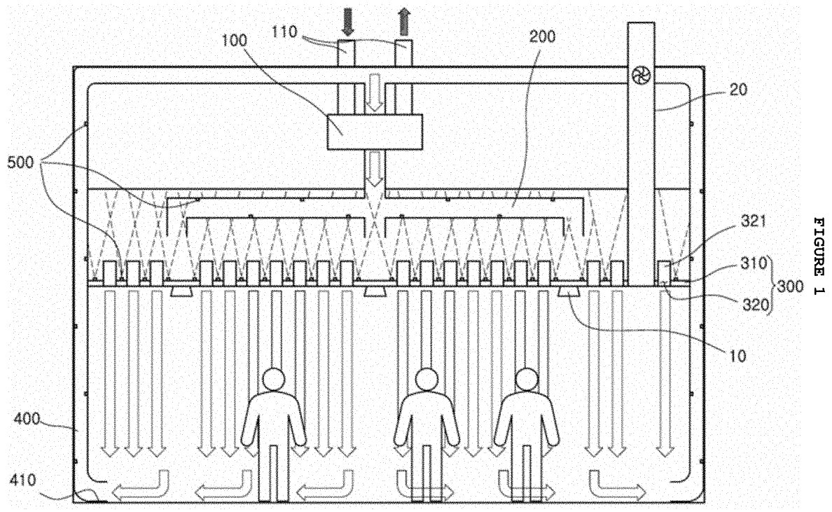

FIG. 1 is a view schematically illustrating the configuration of an air conditioning facility for preventing spread of an infectious disease according to a first embodiment of the present disclosure.

Referring to FIG. 1, the air conditioning facility for preventing spread of the infectious disease according to the first embodiment of the present disclosure may include an air conditioner 100, an air discharge pipe 200, a first chamber 300, and an air suction pipe 400, and an ultraviolet light irradiation unit 500.

The air conditioner 100 is a device that processes air suctioned from an indoor space and re-supply the same back into the indoor space for circulation, and may be exemplified by various types of air conditioners such as air coolers, heaters, air purifiers, and dehumidifiers. As illustrated in FIG. 1, the air conditioner 100 according to the first embodiment of the present disclosure may be installed in an upper area of an indoor space, that is, on the ceiling. However, the installation position of the air conditioner 100 is not limited thereto, and when the indoor space is insufficient, it may be installed in an outdoor space.

A differential pressure pipe 110 that forms a differential pressure between the outdoor space and the indoor space may be connected to the air conditioner 100. The differential pressure pipe 110 may be configured as a pair of pipes having opposite sides respectively connected to the air conditioner 100 and the outdoor space to introduce air from the outside or discharge air to the outside. The differential pressure pipe 110 may form a negative pressure in the indoor space by differentiating the flow rates flowing into and out of the air conditioner 100.

The air discharge pipe 200 may supply air processed by the air conditioner 100 to the first chamber 300 which will be described later. The air discharge pipe 200 according to the first embodiment of the present disclosure may be formed to have a pipe shape in which opposite sides thereof are connected to a discharge hole of the air conditioner 100 and an inner space of the first chamber 300, respectively. A plurality of air discharge pipes 200 may be provided. In this case, the plurality of air discharge pipes 200 may branch and extend from the discharge hole of the air conditioner 100. The plurality of air discharge pipes 200 may divide and supply air processed by the air conditioner 100. A discharge end 201 of each of the air discharge pipes 200 may be disposed at a different position inside the first chamber 300. Thus, the air discharge pipes 200 may uniformly supply air processed by the air conditioner 100 over the entire inner space of the first chamber 300. The number and arrangement of the plurality of air discharge pipes 200 are not limited to those illustrated in FIG. 1, and various design modifications are possible depending on the size, etc. of the first chamber 300.

The first chamber 300 may be formed to have a hollow chamber shape and disposed to face the air discharge pipes 200. The first chamber 300 may discharge air processed by the air conditioner 100 toward the indoor space. Hereinafter, an example in which the first chamber 300 is disposed in the upper area of the indoor space, that is, on the ceiling, will be described. However, the installation position of the first chamber 300 is not limited thereto, and it may also be disposed in a lower area of the indoor space, that is, on the floor.

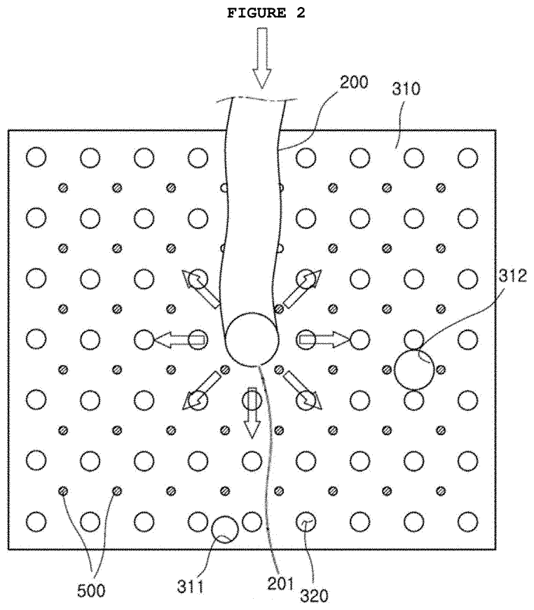

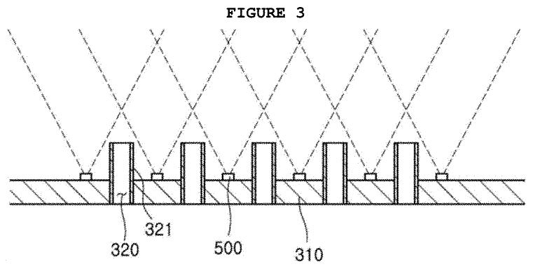

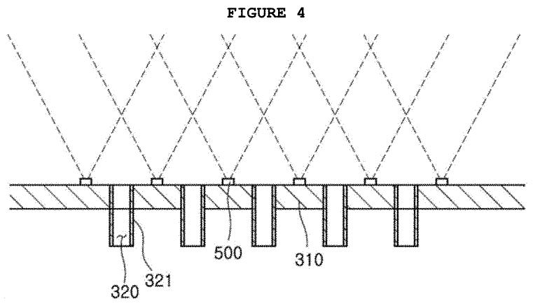

FIG. 2 is a plan view schematically illustrating the configuration of the first chamber according to the first embodiment of the present disclosure. FIGS. 3 and 4 are side views schematically illustrating the configuration of the first chamber according to the first embodiment of the present disclosure.

Referring to FIG. 2, the first chamber 300 according to the first embodiment of the present disclosure may include a first plate 310 and an air discharge hole 320.

The first plate 310 may form the exterior of a side of the first chamber 300, and provide a space in which the air discharge hole 320 which will be described later is provided. The first plate 310 according to the first embodiment of the present disclosure may be formed to have a planar plate shape, and disposed to form the exterior of a lower surface of the first chamber 300. The first plate 310 may be disposed so that an upper surface thereof faces and is spaced apart a predetermined distance from the respective discharge ends 201 of the air discharge pipes 200.

In the first plate 310, a lighting hole 311 for installation of a lighting device 10 such as a lamp and a ventilation hole 312 connected to a ventilation duct 20 may be additionally formed. The lighting hole 311 and the ventilation hole 312 may be disposed so as not to interfere with the air discharge hole 320 which will be described later.

The air discharge hole 320 may be formed through the first plate 310, and may allow air processed by the air conditioner 100 to be discharged toward the indoor space. Thus, air discharged from the air discharge pipe 200 and introduced into the first chamber 300 may stay in the inner space of the first chamber 300 and then be discharged into the indoor space through the air discharge hole 320. The air discharge hole 320 according to the first embodiment of the present disclosure may be formed to have a hole shape passing vertically through the first plate 310 in the vertical direction. A plurality of air discharge holes 320 may be formed in the first plate 310.

As air processed by the air conditioner 100 and flowing into the first chamber 300 through the air discharge pipes 200 is concentrated in the vicinity of the discharge ends 201 of the air discharge pipes 200, the number, position, size, etc. of the plurality of air discharge holes 320 may be varied with respect to the discharge ends 201.

For example, the plurality of air discharge holes 320 may be arranged so that the interval therebetween increases as the distance thereof from the air discharge pipes 200, more specifically, the discharge ends 201, decreases. In other words, the number of the plurality of air discharge holes 320 may be small in the vicinity of the discharge ends 201, and may be large at a position far from the discharge ends 201. Thus, the plurality of air discharge holes 320 may allow air to be uniformly supplied to the indoor space over the entire area of the first plate 310.

In addition, the diameters of the plurality of air discharge holes 320 may decrease as the distance thereof from the air discharge pipes 200, more specifically, the discharge ends 201, decreases. In other words, the diameters of the plurality of air discharge holes 320 may be small in the vicinity of the discharge ends 201, and may be large at a position far from the discharge ends 201. Thus, the plurality of air discharge holes 320 may allow air to be uniformly supplied to the indoor space over the entire area of the first plate 310.

In addition, in order to intensively discharge air to an area where many people stay in the indoor space, the plurality of air discharge holes 320 may be intensively arranged on the first plate 310 disposed to face the area.

The specific number, position, and size of the air discharge holes 320 are not limited to those illustrated in FIG. 2, and various design modifications are possible depending on the capacity of the air conditioner 100, the position of the air discharge pipes 200, the size of the first chamber 300, etc.

Each of the air discharge holes 320 may be connected to an air discharge tube 321 for inducing air discharged from the air discharge hole 320 to flow vertically toward the indoor space. The air discharge tube 321 according to the first embodiment of the present disclosure may be formed to have a tube shape extending vertically from the air discharge hole 320. The air discharge tube 321 may extend vertically upward of the first plate 310 as illustrated in FIG. 3, and alternatively, may extend vertically downward of the first plate 310 as illustrated in FIG. 4. The air discharge tube 321 may improve straightness of air flow when air inside the first chamber 300 is discharged through each of the air discharge holes 320 to form a vertical laminar flow in the indoor space. Thus, the air discharge tube 321 may minimize spread of airborne infectious diseases caused by horizontal movement, convective flow, and turbulent flow of air inside the indoor space.

A plurality of air discharge tubes 321 may be provided, and may be connected to the plurality of air discharge holes 320, respectively. The extension lengths of the plurality of air discharge tubes 321 extending below or above the first plate 310 may be formed to be the same or different for the plurality of air discharge holes 320.

When the extension lengths of the plurality of air discharge tubes 321 are formed to be different from each other, the plurality of air discharge tubes 321 may be arranged so that the extension lengths thereof are proportional to the distance thereof from the discharge ends 201. More specifically, the lengths of the plurality of air discharge tubes 321 may be relatively short at a position in the vicinity of the discharge ends 201, and may be relatively long at a position far from the discharge ends 201. Thus, the plurality of air discharge tubes 321 may allow straightness of air to be maintained in all of the plurality of air discharge holes 320 to which different air pressures are applied depending on the distance thereof from the discharge ends 201, and at the same time, may induce air to be uniformly supplied to the indoor space.

In the first chamber 300, a separate device that helps uniformly supply air processed by the air conditioner 100 over the entire area of the first plate 310, for example, a fan driving device, may be installed.

The air suction pipe 400 may be connected to the indoor space and a suction hole of the air conditioner 100. The air suction pipe 400 may serve as a passage for suctioning air introduced into the indoor space through the air discharge holes 320 and re-supplying the air back to the air conditioner 100.

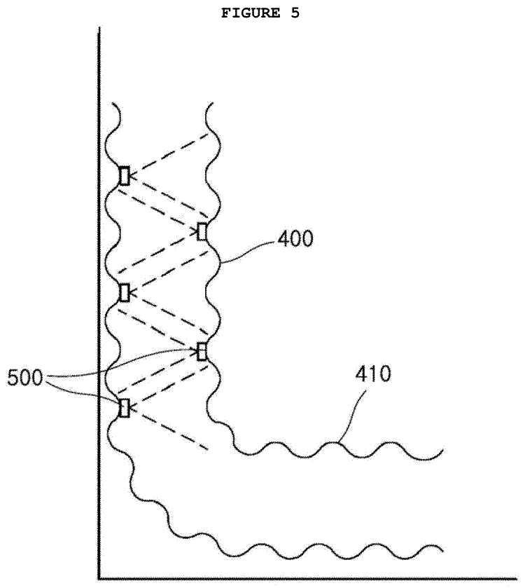

FIG. 5 is a sectional view schematically illustrating the configuration of the air suction pipe according to the first embodiment of the present disclosure.

The air suction pipe 400 according to the first embodiment of the present disclosure may be formed to have a hollow long cylindrical pipe shape with open opposite ends. When the first chamber 300 is disposed in the upper area of the indoor space, an upper end of the air suction pipe 400 may be connected to the suction hole of the air conditioner 100. The air suction pipe 400 may be disposed on the wall of the indoor space so as not to interfere with people or structures in the indoor space. The air suction pipe 400 may be disposed inside the indoor space with respect to the wall, and alternatively, may be disposed outside the indoor space. The air suction pipe 400 may be partially or entirely made of a soft material or provided in the form of a bellows so as to be freely moved in position. Although not illustrated, a fan for air suction may be installed in the air suction pipe 400.

The air discharge pipe 400 may have a suction end 410 for suctioning air from the indoor space. The suction end 410 according to the first embodiment of the present disclosure may form the exterior of each lower end of the air suction pipe 400 that is not connected to the suction hole of the air conditioner 100. The suction end 410 may extend horizontally from the wall of the indoor space and communicate with the inside of the indoor space. In this case, the suction end 410 may be disposed in the vicinity of the floor of the indoor space. Thus, the suction end 410 may induce air to flow horizontally only at a position in the vicinity of the floor, which is a lower point than a person's respiratory system such as nose and mouth, thereby minimizing spread of source of infection through the respiratory system. The suction end 410 may be disposed at a position relatively less accessible by a person, such as an edge or a corner of the indoor space.

The ultraviolet light irradiation unit 500 may be disposed on a path in which air suctioned from the air suction pipe 400 is discharged through the air discharge holes 320, and may emit UV light for sterilization. The ultraviolet light irradiation unit 500 according to the first embodiment of the present disclosure may be provided to emit UV-C light of a wavelength of 100 to 280 nm, which has the strongest sterilization power. The ultraviolet light irradiation unit 500 may be, for example, a UV-C light emitting diode. Here, it is preferable to use a UV-C light emitting diode that blocks or does not generate a wavelength of 184.9 nm, which forms ozone.

A plurality of ultraviolet light irradiation units 500 may be provided, and may be arranged on the upper surface of the first plate 310 of the first chamber 300. In this case, the plurality of ultraviolet light irradiation units 500 may be arranged to be spaced apart from each other in a grid form. The ultraviolet light irradiation units 500 may sterilize air inside the first chamber 300 by emitting UV-C light upward from the first plate 310. In addition, as the UV-C light is emitted upward from ultraviolet light irradiation units 500, damage to the human body caused by UV irradiation may be prevented. The plurality of ultraviolet light irradiation units 500 may also be arranged inside the air discharge pipes 200 and the air suction pipe 400. At this time, it is preferable that the number and installation positions of the ultraviolet light irradiation units 500 are set on the basis of a UV-C discharge angle so that UV-C light is emitted to the entire area inside the air discharge pipe 200 and the air suction pipe 400. The ultraviolet light irradiation units 500 may be provided only at a part of the first plate 310, the air discharge pipe 200, and the air suction pipe 400, and alternatively, may be provided at all of them. Thus, the ultraviolet light irradiation units 500 may allow air to be sterilized for a sufficient time through the path suctioned from the air suction pipe 400 and discharged to the air discharge holes 320, thereby increasing sterilization efficiency.

In the present disclosure, even when the indoor space is in air flow connection with other indoor spaces through the ventilation duct 20, air supplied after being sterilized by the ultraviolet light irradiation units 500 may be discharged through the ventilation duct 20, thereby preventing spread of airborne source of infection to other spaces through the ventilation duct 20.

Hereinafter, the configuration of an air conditioning facility for preventing spread of an infectious disease according to a second embodiment of the present disclosure will be described in detail.

For convenience of explanation, descriptions of contents overlapping those mentioned above will be omitted.

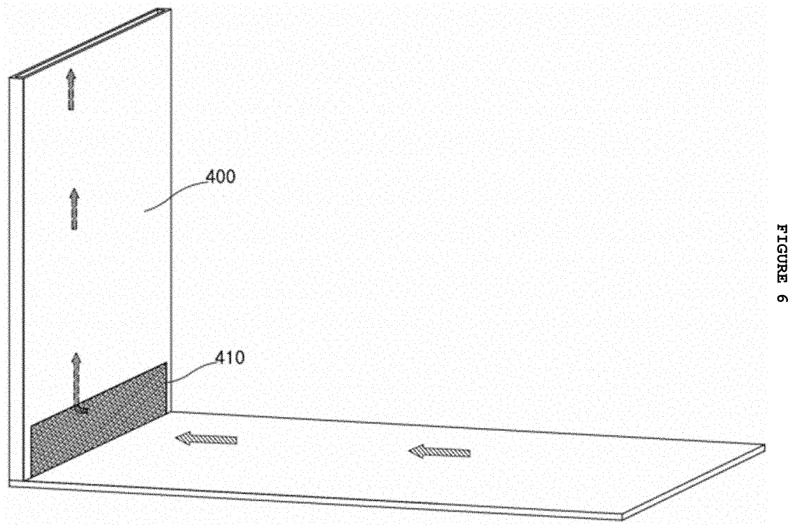

FIG. 6 is a perspective view schematically illustrating the configuration of the air conditioning facility for preventing spread of the infectious disease according to the second embodiment of the present disclosure.

Referring to FIG. 6, an air suction pipe 400 provided in the air conditioning facility for preventing spread of the infectious disease according to the second embodiment of the present disclosure may be formed to have a plate-shaped pipe shape having a rectangular cross-section. The air suction pipe 400 may extend vertically in the vertical direction and be installed on the wall of an indoor space. More specifically, the air suction pipe 400 may be disposed inside the indoor space with respect to the wall, and alternatively, may be disposed outside the indoor space. The horizontal width of the air suction pipe 400 may be formed to be equal to that of the wall. In this case, a suction end 410 provided at a lower end of the air suction pipe 400 may be formed in a grill shape to communicate with the indoor space. Thus, the air suction pipe 400 may suction air vertically discharged from each air discharge tube 321 over the entire width of the wall, thereby preventing the air from failing to be suctioned in the vicinity of the floor and flowing back into an upper area of the indoor space.

Hereinafter, the configuration of an air conditioning facility for preventing spread of an infectious disease according to a third embodiment of the present disclosure will be described in detail.

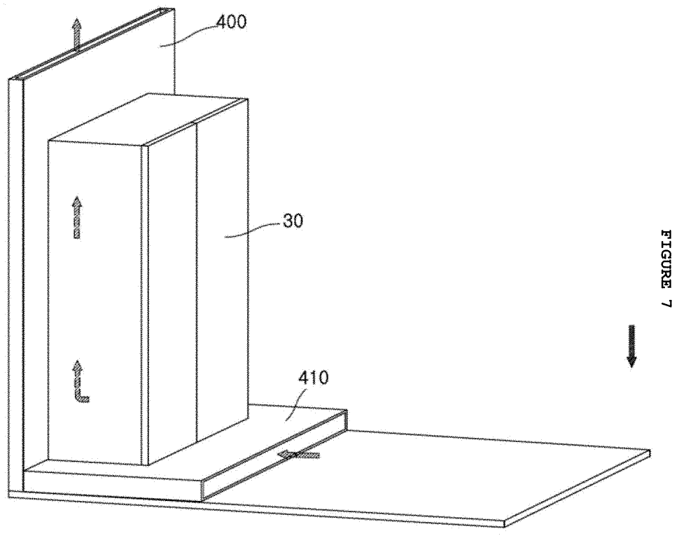

FIG. 7 is a perspective view schematically illustrating the configuration of the air conditioning facility for preventing spread of the infectious disease according to the third embodiment of the present disclosure.

Referring to FIG. 7, as in the case of the air suction pipe 400 according to the second embodiment of the present disclosure, an air suction pipe 400 provided in the air conditioning facility for preventing spread of the infectious disease according to the third embodiment of the present disclosure may be formed to have a plate-shaped pipe shape having a rectangular cross-section.

A section end 410 forming the exterior of a lower end of the air suction pipe 400 may extend horizontally a predetermined distance from the wall in an indoor space toward the inside of the indoor space. In other words, the suction end 410 may be bent from the air suction pipe 400 in a substantially “L” shape and extend toward the inside of the indoor space. A lower surface of the suction end 410 may be supported in contact with the floor of the indoor space. An upper surface of the suction end 410 may be disposed to face the floor of the indoor space horizontally, and a structure 30 such as indoor furniture may be seated thereon. Thus, the suction end 410 may maintain air suction performance even when the structure 30 such as indoor furniture is disposed in the vicinity of the wall. An edge surface of the suction end 410 may be open to communicate with the indoor space. In this case, the edge surface of the suction end 410 may be formed to have a grill shape.

Hereinafter, the configuration of an air conditioning facility for preventing spread of an infectious disease according to a fourth embodiment of the present disclosure will be described in detail.

The air conditioning facility for preventing spread of the infectious disease according to the fourth embodiment of the present disclosure may further include a second chamber 600.

The second chamber 600 may be formed to have a hollow chamber shape and may be disposed to be spaced apart from the first chamber 300. The second chamber 600 may suction air from an indoor space and deliver the air to an air suction pipe 400. Hereinafter, since the first chamber 600 is disposed on the ceiling of the indoor space, an example in which the second chamber 600 is disposed in a lower area of the indoor space, that is, inside the floor. However, the installation position of the second chamber 600 is not limited thereto, and various design modifications are possible within the range of being spaced apart from the first chamber 300, such as being disposed in an upper area of the indoor space, that is, on the ceiling.

In this case, a suction end 410 of the air suction pipe 400 may extend toward the inside of the floor of the indoor space and communicate with the inner space of the second chamber 600. Thus, the air suction pipe 400 and the second chamber 600 may induce air vertically discharged into the indoor space through each air discharge tube 321 to be suctioned through the floor without changing its flow direction, thereby preventing spread of airborne infectious diseases caused by horizontal movement, convective flow, and turbulent flow of air. A plurality of suction ends 410 may be provided, and may be connected to the second chamber 600 at a plurality of points. The plurality of suction ends 410 may be separately provided in different air suction pipes 400, and may be provided in a form branched from one air suction pipe 400.

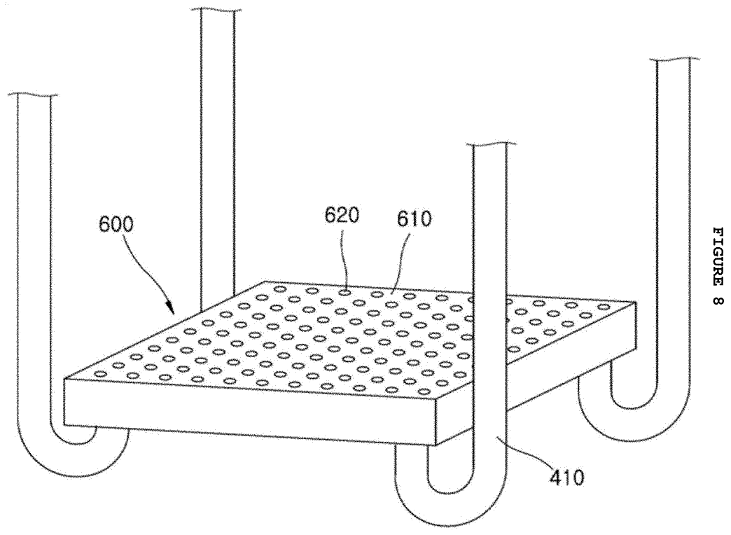

FIG. 8 is a perspective view schematically illustrating the configuration of the second chamber according to the fourth embodiment of the present disclosure.

Referring to FIG. 8, the second chamber 600 according to the fourth embodiment of the present disclosure may include a second plate 610 and an air suction hole 620.

The second plate 610 may form the exterior of a side of the second chamber 600, and may provide a space in which the air suction hole 620 which will be described later is provided. The second plate 610 according to the fourth embodiment of the present disclosure may be formed to have a planar plate shape, and may be disposed to form the exterior of an upper surface of the second chamber 600 or form the floor of the indoor space.

The air suction hole 620 may be formed through the second plate 610, and may suction air from the indoor space into the second chamber 600. The air suction hole 620 according to the fourth embodiment of the present disclosure may be formed to have a hole shape vertically passing through the second plate 610 in the vertical direction.

A plurality of air suction holes 620 may be formed in the second plate 610. As air flowing into the second chamber 600 through the plurality of air suction holes 620 is concentrated in the vicinity of the suction ends 410 of the air suction pipe 400, the number, position, size, etc. of the plurality of air suction holes 620 may be varied with respect to the suction ends 410.

For example, the plurality of air suction holes 620 may be arranged so that the interval therebetween increases as the distance from the air discharge pipe 200, more specifically, the suction ends 410, decreases. In other words, the number of the plurality of air suction holes 620 may be small in the vicinity of the suction ends 410, and may be large at a position far from the suction ends 410. Thus, the plurality of air suction holes 620 may induce air to be uniformly introduced into the second chamber 600 over the entire area of the second plate 610.

In addition, the diameters of the plurality of air suction holes 620 may decrease as the distance thereof from the suction ends 410 decreases. In other words, the diameters of the plurality of air suction holes 620 may be small in the vicinity of the suction ends 410, and may be large at a position far from the suction ends 410. Thus, the plurality of air suction holes 620 may induce air to be uniformly introduced into the second chamber 600 over the entire area of the second plate 610.

In addition, in order to intensively suction air from an area where many people do not stay in the indoor space, the plurality of air suction holes 620 may be intensively arranged on the second plate 610 disposed to face the area.

The specific number, position, and size of the air suction holes 620 are not limited to those illustrated in FIG. 8, and various design modifications are possible depending on the size of the indoor space, the positions of the suction ends 410, and the size of the second chamber 600.

In the second chamber 600, a separate device that helps uniformly distribute the flow rate and speed of air over the entire area of the second plate 610, for example, a fan-type propeller driving device, may be installed.

Hereinafter, the configuration of an air conditioning facility for preventing spread of an infectious disease according to a fifth embodiment of the present disclosure will be described in detail.

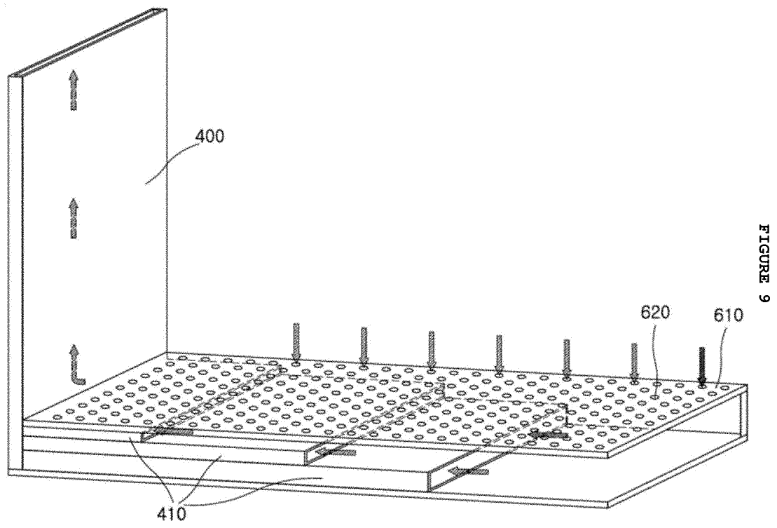

FIG. 9 is a perspective view schematically illustrating the configuration of the air conditioning facility for preventing spread of the infectious disease according to the fifth embodiment of the present disclosure.

Referring to FIG. 9, as in the case of the air suction pipe 400 according to the second embodiment of the present disclosure, an air suction pipe 400 provided in the air conditioning facility for preventing spread of the infectious disease according to the fifth embodiment of the present disclosure may be formed to have a plate-shaped pipe shape having a rectangular cross-section.

A section end 410 forming the exterior of a lower end of the air suction pipe 400 may be bent in a substantially “L” shape from the air suction pipe 400 and disposed inside a second chamber 600. A plurality of suction ends 410 may be provided, and may be arranged inside the second chamber 600. The plurality of suction ends 410 may be separately provided in different air suction pipes 400, and may be provided in a form branched from one air suction pipe 400. The plurality of suction ends 410 may be arranged to be stacked in the vertical direction inside the second chamber 600. The plurality of suction ends 410 may extend from the wall of an indoor space to have to have different lengths. The cross-sectional areas of the plurality of suction ends 410 may increase as the extension lengths thereof from the wall of the indoor space increase. Thus, the plurality of suction ends 410 may allow the flow rate and speed of air suctioned into the air suction pipe 400 from the second chamber 600 to be maintained constant regardless of the distance thereof from the wall.

Although a preferred embodiment of the present disclosure has been disclosed for illustrative purposes, those skilled in the art will appreciate that various modifications, additions, and substitutions are possible, without departing from the scope and spirit of the present disclosure.

It is thus well known to those skilled in that art that the patent right of the present disclosure should be defined by the scope and spirit of the present disclosure as disclosed in the accompanying claims.

1. An air conditioning facility for preventing spread of an infectious disease, the air conditioning facility comprising:
a first chamber having a plurality of air discharge holes configured to allow air processed by an air conditioner to be discharged toward an indoor space;
an air suction pipe connected to the indoor space and a suction hole of the air conditioner and having a suction end configured to allow air to be suctioned from the indoor space; and
an ultraviolet light irradiation unit disposed on a path in which air suctioned from the air suction pipe is discharged through the air discharge holes and configured to emit UV light for sterilization.

2. The air conditioning facility of claim 1, wherein the ultraviolet light irradiation unit comprises a UV-C light emitting diode.

3. The air conditioning facility of claim 1, wherein the ultraviolet light irradiation unit is disposed at least one of inside the air suction pipe and on an upper surface of the first plate of the first chamber.

4. The air conditioning facility of claim 1, wherein the air suction pipe is made of a soft material or provided in the form of a bellows.

5. The air conditioning facility of claim 1, wherein the suction end is disposed in a lower area of the indoor space.

6. The air conditioning facility of claim 5, wherein the suction end is provided in a plate shape and extends a predetermined distance from a wall in the indoor space.

7. The air conditioning facility of claim 1, further comprising a second chamber spaced apart from the first chamber and having a plurality of air suction holes configured to allow air to be suctioned from the indoor space.

8. The air conditioning facility of claim 7, wherein the suction end comprises a plurality of suction ends, and the plurality of suction ends are connected to the second chamber.

9. The air conditioning facility of claim 8, wherein the plurality of suction ends extend from a wall of the indoor space to have different lengths and are disposed inside the second chamber.

10. The air conditioning facility of claim 9, wherein cross-sectional areas of the plurality of suction ends increase as extension lengths thereof from the wall of the indoor space increase.

11. The air conditioning facility of claim 7, wherein an interval between the plurality of air suction holes increases as a distance thereof from the suction end decreases.

12. The air conditioning facility of claim 7, wherein diameters of the plurality of air suction holes decrease as a distance thereof from the suction end decreases.

13. The air conditioning facility of claim 1, further comprising an air discharge pipe connected to a discharge hole of the air conditioner and the first chamber, and configured to supply air processed by the air conditioner to the first chamber.

14. The air conditioning facility of claim 13, wherein the air discharge pipe comprises a plurality of air discharge pipes, and the plurality of air discharge pipes are branched from the discharge hole of the air conditioner.

15. The air conditioning facility of claim 13, wherein the ultraviolet light irradiation unit is disposed inside the air discharge pipe.

16. The air conditioning facility of claim 13, wherein an interval between the plurality of air discharge holes increases as a distance thereof from the air discharge pipe decreases.

17. The air conditioning facility of claim 13, wherein diameters of the plurality of air discharge holes decrease as a distance thereof from the air discharge pipe decreases.

18. The air conditioning facility of claim 1, further comprising an air discharge tube connected to each of the air discharge holes, and configured to induce air discharged from the air discharge hole to flow vertically toward the indoor space.

19. The air conditioning facility of claim 18, wherein the air discharge tube extends upward or downward from the first plate of the first chamber.
